(19) United States
(12) Patent Application Publication
(10) Pub. No.: US 2025/0283755 A1
(43) Pub. Date: Sep. 11, 2025

(54) NEUROMORPHIC CAMERA IN A LASER WARNING SYSTEMS (LWS)

(71) Applicants: NATIONAL RESEARCH COUNCIL OF CANADA, Ottawa (CA); HIS MAJESTY THE KING IN RIGHT OF CANADA, AS REPRESENTED BY THE MINISTER OF NATIONAL DEFENCE, Ottawa (CA)

(72) Inventors: Antony Orth, K1A 0R6 (CA); Terrence Stewart, St. Clements (CA); Michel Picard, Orleans (CA); Marc-Antoine Drouin, Gatineau (CA); Francis Theberge, Shannon (CA)

(21) Appl. No.: 18/876,168

(22) PCT Filed: Jun. 23, 2023
(86) PCT No.: PCT/IB2023/056482

§ 371 Date: Dec. 17, 2024

Related U.S. Application Data
(60) Provisional application No. 63/460,252, filed on Apr. 18, 2023.

(30) Foreign Application Priority Data
Jun. 22, 2022 (CA) 3173954

(51) Int. Cl. G01J 1/42; G01J 1/04

(52) U.S. Cl. CPC G01J 1/4257; G01J 1/0411; G01J 1/0437

(57) ABSTRACT

A target located method and apparatus for the detection of lasers directed at the target using neuromorphic cameras which improve the detection by use of defocus.

### FIELD OF THE INVENTION

Laser warning systems and more specifically laser warning systems incorporating neuromorphic cameras

### BACKGROUND

Lasers aimed at aircraft put the safety of pilots, crews and passengers at risk. During a laser incident, the pilot may become distracted or temporarily blinded during critical maneuvers.

The use of a laser detector, known as a laser warning system (LWS), can confirm the moment of the incident, the origin of the laser pointer and potentially the wavelength, intensity, and exposure time. This information can be used for prosecution and for evaluating the risk of eye injury.

LWSs are also widely used in military applications for threat detection. Camera-based LWSs have higher angular resolution than photodiode-based systems due to the larger number of pixels. However, photodiode-based systems are smaller and draw less power. Although a small footprint LWS is desirable, the physical size of the aperture can limit the sensitivity of the overall system. These tradeoffs must be considered in choosing the appropriate LWS for a given application.

Generally, LWSs should have wide field-of-view in order to limit the number of systems to implement on a platform for having a full coverage against potential incidence of laser threats. In addition to its field-of-view, LWSs must have high angular resolution to provide precise information on the laser beam origin. The possibility for the LWS to measure the repetition rate, intensity, and/or the wavelength of incident laser beams would allow also a better identification of the laser threats and the capability to provide the best protection. Finally, in parallel to these requirements, LWSs must not trigger on bright events like, for examples, glittering of sunlight on water surface or from light reflections from street signs to avoid false positive alarms.

### SUMMARY

According to an aspect of the invention there is herein described in greater detail a Laser Warning System (LWS) comprising:
A neuromorphic camera, and
A lens,
wherein the lens is coupled to the neuromorphic camera along an optical path in slight defocus.

Variants of this aspect include: The Laser Warning System (LWS) wherein the camera has a pixelated sensor and the defocus is calibrated to spread an incoming beam across multiple pixels; The Laser Warning System (LWS) wherein the number of multiple pixels is at least 10; The Laser Warning System (LWS) wherein the defocus is induced by at least one of optical path spacing and a optical dispersive element; The Laser Warning System (LWS) wherein the lens set to image a plane at a distance z<infinity, thereby producing a laser spot across said multiple pixels when illuminated with a laser beam; The Laser Warning System (LWS) of claim 1 wherein said lens is a fisheye lens; The Laser Warning System (LWS) of claim 2 wherein said spread is adjustable using an aperture stop;

According to another aspect of the invention there is herein described in greater detail a method of laser detection comprising:
detecting a laser beam using a neuromorphic camera, and a lens,
wherein the lens is coupled to the neuromorphic camera along an optical path in slight defocus.

Variants of this other aspect include: The method wherein the camera has a pixelated sensor and the defocus is calibrated to spread an incoming beam across multiple pixels; The method wherein the number of multiple pixels is at least 10; The method wherein the defocus is induced by at least one of an optical path spacing and an optical dispersive element; The method wherein the lens set to image a plane at a distance z<infinity, thereby producing a laser spot across said multiple pixels when illuminated with a laser beam; The method of claim 1 wherein said lens is a fisheye lens; The method wherein said spread is adjustable using an aperture stop; The method wherein multiple laser centroids are produced by said optical dispersive element.

### BRIEF DESCRIPTION OF THE DRAWINGS

The drawings have not necessarily been drawn to scale. Similarly, some components and/or operations can be separated into different blocks or combined into a single block for the purposes of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

FIG. 1 is a schematic setup and event density output according to an aspect of the invention.

FIG. 2 is a polynomial fit according to an aspect of the invention.

FIG. 3 is a x-y distribution of statistical results according to an aspect of the invention.

FIG. 4 is a graph of angle error according to an aspect of the invention.

FIG. 5 a graph of event frequency response function and frequency cutoff according to an aspect of the invention.

### DETAILED DESCRIPTION

Systems and methods for Laser detection are described herein. In the following description, for the purposes of explanation, numerous specific details are set forth in order to provide a thorough understanding of implementations of the present technology. It will be apparent, however, to one skilled in the art that implementations of the present technology can be practiced without some of these specific details.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some implementations,” “according to some implementations,” “in the implementations shown,” “in other implementations,” and the like generally mean the particular feature, structure, or characteristic following the phrase is included in at least one implementation of the present technology, and can be included in more than one implementation. In addition, such phrases do not necessarily refer to the same implementations or different implementations.

Unlike traditional cameras that record the intensity of light and produce an image of the target, a neuromorphic camera records variation in the light intensity in time. This can be thought of as a differential or first order derivative of the intensity. These changes in light-intensity, or events, are why neuromorphic cameras are commonly called event cameras.

Neuromorphic cameras are attractive for use in a LWS because laser attacks are expected to be infrequent events and neuromorphic cameras require processing only when events are registered. This would enable a LWS to be deployed with limited power consumption and a small physical footprint compared to a LWS based on a traditional image sensor. Moreover, for fast moving laser threats, localization with a neuromorphic sensor is not restricted by the frame rate of a synchronous readout camera, which also requires a significant power draw to operate at an elevated refresh-rates. A neuromorphic LWS has the potential to combine the best of both worlds—high resolution, high sensitivity laser threat detection with a low power draw.

According to an aspect of the invention there is provided a Laser Warning System (LWS) comprising a neuromorphic camera, and a fisheye lens, wherein the fisheye lens is coupled to the neuromorphic camera along an optical path in slight defocus.

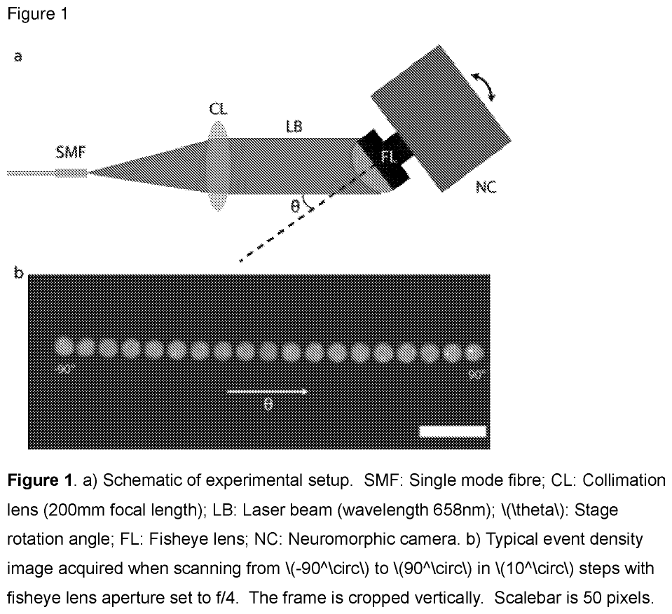

In order to verify the efficacy of this approach, an experimental test bench was built to assess the performance of a neuromorphic camera for laser event detection and localization. A schematic of the system is shown in FIG. 1. The camera (an iniVation DAVIS346) was mounted on an automated rotation stage (PI M-060PD) in the path of a collimated laser beam (658nm). The laser beam was collimated from the output of a single mode fiber by a 2-inch diameter 200 mm focal length plano-convex lens. The camera was fitted with a fisheye lens (Edmund Optics 62-274) that filled the camera sensor with a circle of diameter approximately equal to the frame height. Thus, the camera observes a full hemisphere field of view (FOV).

The image projected onto the camera sensor is made slightly out of focus by using a c-mount spacer ring between the lens and camera. Because of this defocus, the image of the collimated laser beam on the camera sensor was approximately 10 pixels in diameter when the fisheye lens aperture is set to f/4. This defocus increased the precision in localizing a light source incident on the lens. If the laser beam was instead imaged in focus, it would have spanned less than a pixel on the sensor. In this situation, localization precision is poor due to the relatively large discretization and low fill factor of the sensor. However, when imaged with defocus, the event-weighted centroid of the ˜10 pixels wide spot was reliably estimated to within a fraction of a pixel diameter. The improvement in estimation due to defocus could also be achieved through placement of an optical dispersive element in the optical path. This could be in conjunction with a spacer or in the alternative.

Because the collimated laser beam was located at optical infinity, the displacement of the image of a focused spot is expected to vary linearly on the image sensor under the paraxial (small angle) approximation.

The spot position vs. angle relationship was measured experimentally by acquiring 4 s of event data for 10 equally spaced stage rotation angles from −90 to +90 degrees. The laser beam was set to pulse at 10 Hz with a duty cycle of 5%. The time averaged power incident on the fisheye lens was 81 nW (all powers reported are for the total power incident on the 50 mm diameter fisheye lens). From this 4 s event stream for each angle, the event-weighted centroid was calculated. To filter out noise, a morphological opening with a 3×3 square pixel kernel was performed prior to centroid calculation.

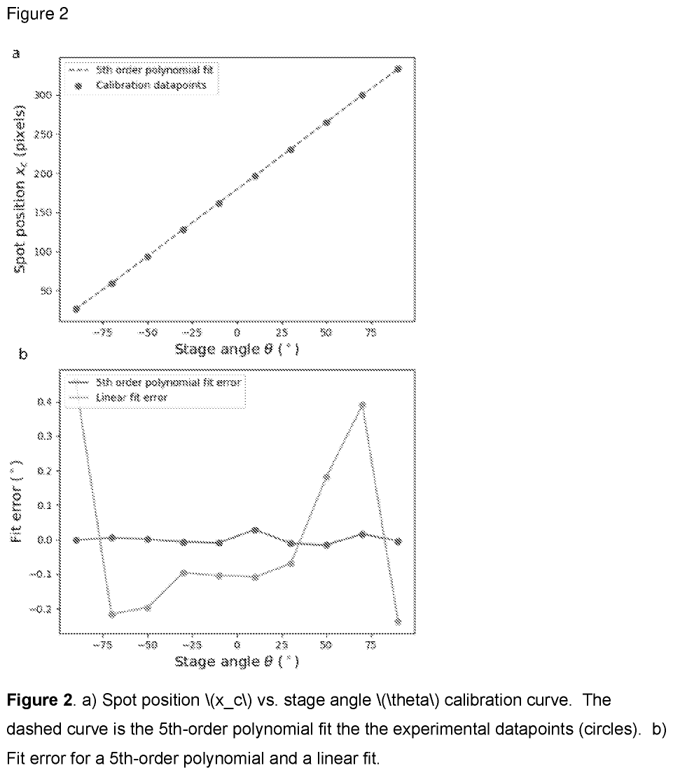

In FIG. 2a we show the event-weighted centroid position along the x-axis (the direction of rotation) as a function of stage angle. Although the trend is nearly linear, a linear fit fails to accurately capture the position of the spot at the extremes of the FOV (FIG. 2b). The root-mean-squared error (RMSE) of the linear fit is 0.024 degrees when averaged over the 180 degrees range of rotation. Although the error of a linear fit is large at the edges of the FOV, the slope of the fit gives an approximate indication of the angular sampling of the camera and fisheye system: 0.58 degrees per pixel. To eliminate the systematic errors from a linear calibration, we instead fit a 5th order polynomial to the data. This polynomial fit yielded a RMSE of 0.013 degrees with roughly uniform magnitude over the FOV.

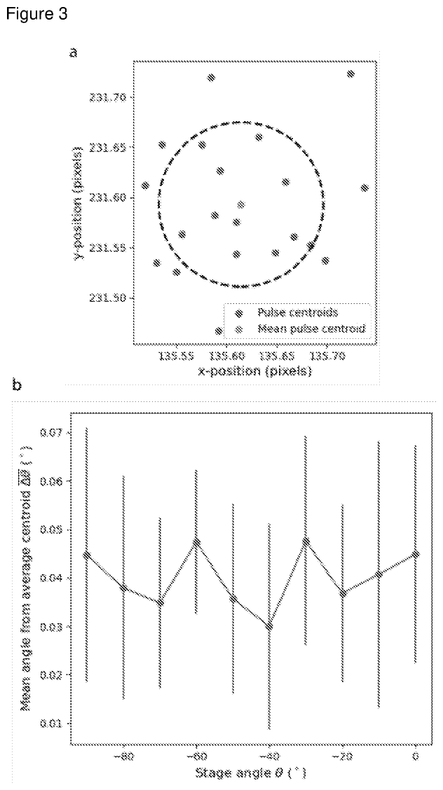

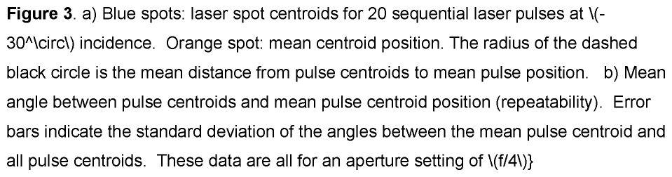

We assessed the resolution of the neuromorphic laser warning system by measuring the standard deviation of a stationary spot. The laser was set to pulse at 10 Hz with 5% duty cycle, and for each pulse the event-weighted centroid was calculated. A typical distribution of the spot centroids (shown in blue) is shown in FIG. 3a for an angle of incidence of −30 degrees and aperture setting of f/4; the mean position of the spot centroids is shown in orange. The same measurement was performed for an angle of incidence ranging from −90 to 0 degrees along the horizontal (x) direction. The resulting mean angle from the average centroid is shown in FIG. 3b. It was found that f/4 provides a good tradeoff between spot size and increased signal, with repeatability degrading at either very small or very large aperture settings.

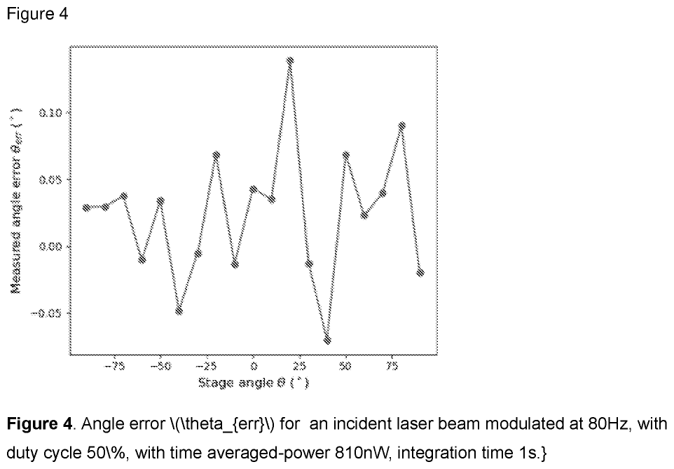

The accuracy of the neuromorphic LWS was investigated by measuring laser spot positions at varying stage angles across the FOV and comparing with the ground truth angle of incidence given by the stage position. After finding the centroid position on the image sensor, the measured angle of incidence of the laser was found according to the polynomial fit. A typical example of the difference between the measured angle and the stage angle is shown in FIG. 4. For this example, the laser was modulated at 80 Hz (duty cycle 50%), with an integration time of 1 s. The RMSE of the measured angle of incidence in this case is 0.054 degrees.

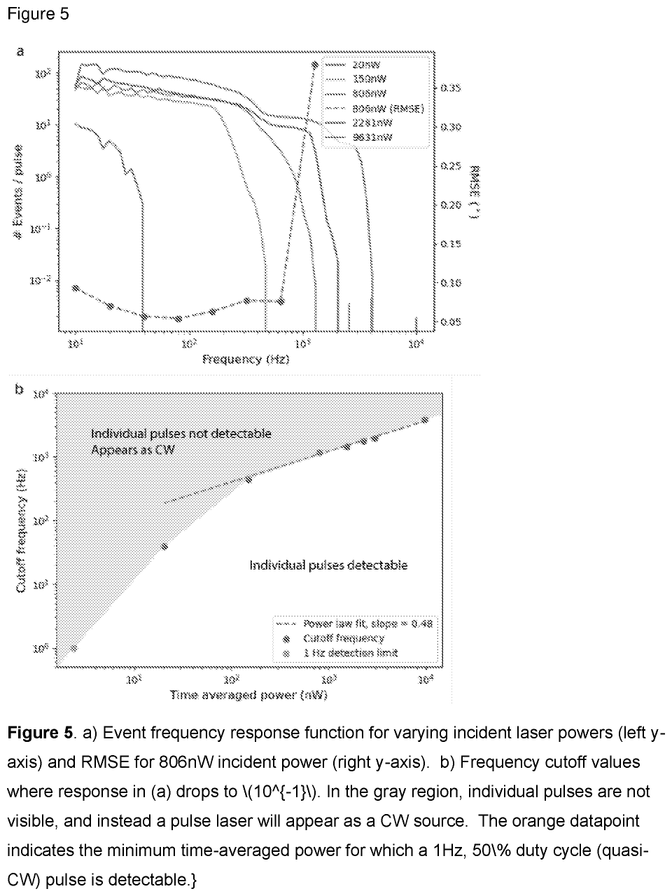

This RMSE value depends on the laser modulation frequency due to the high pass filter in the neuromorphic camera circuitry. For all experimental data herein, the bias settings were tuned manually to increase responsiveness at high frequencies. In FIG. 5a, (same illumination parameters as for FIG. 4), the RMSE (green dashed curve) initially improves with increasing laser modulation frequency (due to more events per unit time) and then degrades rapidly at ˜1 kHz when the cutoff frequency of the neuromorphic camera's hardware is reached. To illustrate the effect of frequency on the response of the neuromorphic camera, we measured the event frequency response function for incident powers ranging from 20 nW to 9631 nW, as shown in FIG. 5a. While the event response rate drops sharply at higher frequencies, the value of the cut off frequency increases with increasing power. We define the cutoff frequency as the frequency at which the number of events per pulse drops to 1/10th; the resulting cutoff frequencies are plotted in FIG. 5b. At 20 nW incident power, repeated pulses are not detectable above 40 Hz compared to a cutoff of 4 kHz at 9631 nW. Above the cutoff, individual pulses are not detectable and instead, the laser appears as a continuous wave (CW) source: the laser is observable only when it is turned on or off. For a quasi-CW source pulsing at 1 Hz, we measured a detection limit of 1.2 nW of time averaged incident power.

Herein it is shown that a neuromorphic LWS has the potential to combine the advantages of photodiode-based LWSs and camera-based ones: high resolution, high sensitivity laser threat detection with a low power draw.

The strong frequency dependent response shown is a reminder that the ability of neuromorphic cameras to capture fast dynamics is not completely captured by the sensor's timing accuracy or latency metrics. The actual single pixel frequency response is significantly slower than the timing accuracy may suggest.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize In addition, while processes, message/data flows, or blocks are presented in a given order, alternative implementations may perform routines having blocks, or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements, blocks and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology.

1. A Laser Warning System (LWS) comprising:
A neuromorphic camera, and
A lens,
wherein the lens is coupled to the neuromorphic camera along an optical path in slight defocus.

2. The Laser Warning System (LWS) of claim 1 wherein the camera has a pixelated sensor and the defocus is calibrated to spread an incoming beam across multiple pixels.

3. The Laser Warning System (LWS) of claim 2 wherein the number of multiple pixels is at least 10.

4. The Laser Warning System (LWS) of claim 1 wherein the defocus is induced by at least one of optical path spacing and a optical dispersive element.

5. The Laser Warning System (LWS) of claim 2 wherein the lens set to image a plane at a distance z<infinity, thereby producing a laser spot across said multiple pixels when illuminated with a laser beam.

6. The Laser Warning System (LWS) of claim 1 wherein said lens is a fisheye lens.

7. The Laser Warning System (LWS) of claim 2 wherein said spread is adjustable using an aperture stop.

8. A method of laser detection comprising:
detecting a laser beam using a neuromorphic camera, and a lens,
wherein the lens is coupled to the neuromorphic camera along an optical path in slight defocus.

9. The method of claim 8 wherein the camera has a pixelated sensor and the defocus is calibrated to spread an incoming beam across multiple pixels.

10. The method of claim 9 wherein the number of multiple pixels is at least 10.

11. The method of claim 8 wherein the defocus is induced by at least one of an optical path spacing and an optical dispersive element.

12. The method of claim 9 wherein the lens set to image a plane at a distance z<infinity, thereby producing a laser spot across said multiple pixels when illuminated with a laser beam.

13. The method of claim 8 wherein said lens is a fisheye lens.

14. The method of claim 9 wherein said spread is adjustable using an aperture stop.

15. The method of claim 11 wherein multiple laser centroids are produced by said optical dispersive element.
